(19) United States
(12) Patent Application Publication
(10) Pub. No.: US 2009/0265050 A1
(43) Pub. Date: Oct. 22, 2009

(54) AIRCRAFT PILOT KNEEBOARD WITH MILITARY MOVING MAP AND BROWNOUT/OBSCURED LANDING SYSTEM

(76) Inventor: Douglas Burpee, Pasadena, CA (US)

Correspondence Address: CHRISTIE, PARKER & HALE, LLP, PO BOX 7068, PASADENA, CA, 91109-7068, US

(21) Appl. No.: 11/782,932

(22) Filed: Jul. 25, 2007

(51) Int. Cl. G06G 7/70; G06F 19/00; G05D 1/00; A47B 85/00; A47B 23/00

(52) U.S. Cl. 701/16; 701/3; 108/23; 108/43

(57) ABSTRACT

An aircraft pilot kneeboard is provided including a bottom member having an inner compartment. A top member is connected to the bottom member by a first axle. Flanges extend outwardly from the bottom member. Straps are attached to the flanges. Springs are located in the flanges for holding writing instruments. The springs have turns distanced less than a diameter of the writing instruments. Clamps are located at lower and upper edges of the top member. A tiltable surface is connected to an upper surface of the second clamp by a second axle. The second axle extends widthwise across the kneeboard. The kneeboard further includes a light emitting diode for lighting a top surface of the top member. The kneeboard further includes an interactive screen attached to the tiltable surface for providing a military moving map and a brownout/obscured landing system.

### BACKGROUND OF THE INVENTION

1. Field of the Invention

The present invention relates generally to a kneeboard for aircraft pilots, and more particularly, to a kneeboard having an attached interactive screen displaying a military moving map and a brownout/obscured landing system.

2. Description of Related Art

Currently, military preflight planning is done via a computer. Mission plans are typically made graphically via a military flight planning tool such as the FalconView®/JUMPS mapping system. FalconView® is a registered trademark of Georgia Tech Research Institute. The plan is usually printed on paper and given to the pilots prior to conducting their missions. Determining the aircraft's position on the flight plan can be difficult, time consuming, and error ridden when transposing Global Positioning System (GPS) data and manually overlaying to a paper map. Although pilots always have heads-down time in the cockpit with these types of activities, reducing this time increases safety. Pilots need to spend as much time as possible looking outside while flying. Therefore, a need exists for a system that provides instant positional situational awareness and for tools to make changes to flight plan activities effectively and efficiently while piloting an aircraft.

Further, brownout/obscured landings have long been a problem for helicopter operations around the world, particularly in the Middle East. The fine, flour like dust makes it near impossible to conduct a safe landing without a visual reference. When landing in such conditions, the pilot loses visual contact with the ground, after being engulfed in a self induced cloud of blowing dust. These conditions can induce vertigo causing the pilot to lose control and crash the helicopter. When performing a brownout/obscured landing as with any landing, the pilot initiates the landing phase by visually identifying a landing site, establishing a landing profile with a desired rate of descent and an aircraft pitch to decelerate the helicopter to land with zero groundspeed at zero altitude. As the aircraft proceeds down the glide slope, the aircraft is engulfed in a self generated dust cloud at approximately 75 feet or the diameter of the rotor blades, whichever is less. Most helicopters have only five of the six instrument references needed to complete a safe landing: an Attitude Direction Indicator (ADI) to determine aircraft pitch, a GPS to determine ground speed, Vertical Speed Indicator (VSI) to determine closure rate speed to the ground, a Radar Altimeter (RADALT) to determine actual height above the ground, and a compass for heading indication. Current helicopters do not have a drift instrument for landing. The pilot normally ascertains drift movement by looking outside the helicopter. An outside visual reference allows a pilot to manipulate the aircraft controls to stop any drift prior to landing. When landing in brownout/obscured landing conditions, a pilot does not have a visual drift reference because the pilot can not see the ground. Helicopters that do have a drift instrument (e.g., a Doppler radar) are not used for landing but rather for performing hover operations to maintain a fixed position hover during water operations, rescue operations, and other types hover operations where the helicopter must maintain a fixed position over the ground when unable to do so when a ground reference is unavailable. As such, drift instruments used for hover operations do not effectively display a visual simulation of the ground that a pilot is accustomed to seeing to ascertain drift for landing.

Therefore, a need exists for a low cost, effective visual simulation of the ground that provides the pilot with all of the information needed to complete a safe landing, and most importantly, provides the pilot with a drift reference to effectively conduct a safe landing in brownout/obscured landing situations.

### SUMMARY OF THE INVENTION

A method for operating a brownout/obscured landing system is provided. In the method, data indicating aircraft position is received. In addition, a three dimensional perspective grid is displayed on a display. Furthermore, the grid on the display is moved in response to the aircraft position.

In an exemplary embodiment of the present invention, the data indicating aircraft position includes aircraft latitude and longitude information received through a Global Positioning System, aircraft heading information, aircraft altitude information, and aircraft attitude information.

In an exemplary embodiment of the present invention, the grid on the display is moved by shifting the grid corresponding to the aircraft latitude and longitude information, rotating the grid along a surface of the grid corresponding to the aircraft heading information, resizing the grid corresponding to aircraft altitude information, and tilting the grid corresponding to aircraft attitude information.

In an exemplary embodiment of the present invention, the grid overlaid with geographical references is displayed.

In an exemplary embodiment of the present invention, the aircraft heading information is displayed, the aircraft altitude information is displayed, and aircraft ground speed information is displayed. The aircraft ground speed information is determined by comparing the aircraft latitude and longitude information.

In an exemplary embodiment of the present invention, a user is allowed to preprogram a landing zone. The landing zone is displayed by highlighting or marking a section of the grid.

In an exemplary embodiment of the present invention, a landing zone is calculated by projection based on a rate of decent and a decelerating airspeed. The landing zone is displayed by highlighting or marking a section of the grid.

In an exemplary embodiment of the present invention, a user is allowed to preprogram a first landing zone. A second landing zone is calculated by projection based on aircraft movement. The first landing zone is displayed by highlighting or marking a corresponding section of the grid. The second landing zone is displayed by highlighting or marking a corresponding section of the grid.

A brownout/obscured landing system is provided including a processor, a display coupled to the processor, and a memory operably coupled to the processor. The memory has program instructions stored therein. The processor is operable to execute the program instructions. The program instructions include instructions for receiving data indicating aircraft position, instructions for displaying a three dimensional perspective grid on the display, and instructions for moving the grid on the display in response to the aircraft position.

In an exemplary embodiment of the present invention, the instructions for receiving data indicating aircraft position includes instructions for receiving aircraft latitude and longitude information through a Global Positioning System, instructions for receiving aircraft heading information, instructions for receiving aircraft altitude information, and instructions for receiving aircraft attitude information.

In an exemplary embodiment of the present invention, the instructions for moving the grid on the display includes instructions for shifting the grid corresponding to the aircraft latitude and longitude information, instructions for rotating the grid along a surface of the grid corresponding to the aircraft heading information, instructions for resizing the grid corresponding to aircraft altitude information, and instructions for tilting the grid corresponding to aircraft tilt information.

In an exemplary embodiment of the present invention, the program instructions further include instructions for displaying the grid overlaid with geographical references.

In an exemplary embodiment of the present invention, the program instructions further include instructions for displaying the aircraft heading information, instructions for displaying the aircraft altitude information, and instructions for displaying aircraft ground speed information. The aircraft ground speed information is determined by comparing the aircraft latitude and longitude information.

In an exemplary embodiment of the present invention, the program instructions further include instructions for allowing a user to preprogram a landing zone, and instructions for displaying the landing zone by highlighting or marking a section of the grid.

In an exemplary embodiment of the present invention, the program instructions further include instructions for calculating a landing zone by projection based on a rate of decent and a decelerating airspeed, and instructions for displaying the landing zone by highlighting or marking a section of the grid.

In an exemplary embodiment of the present invention, the program instructions further include instructions for allowing a user to preprogram a first landing zone, instructions for calculating a second landing zone by projection based on aircraft movement, instructions for displaying the first landing zone by highlighting or marking a corresponding section of the grid, and instructions for displaying the second landing zone by highlighting or marking a corresponding section of the grid.

A kneeboard is provided including a bottom member having an inner compartment. A top member is connected to the bottom member by a first axle. A first flange and a second flange extend outwardly from the bottom member. The first flange has a first flange strap slot and a first flange spring slot. The second flange has a second flange strap slot and a second flange spring slot. Straps are attached to the first flange strap slot and the second flange strap slot. Springs are located in the first flange spring slot and the second flange spring slot for holding writing instruments. The springs have turns distanced less than a diameter of the writing instruments. A first clamp is located at a lower edge of the top member. A second clamp is located at an upper edge of the top member. A tiltable surface is connected to an upper surface of the second clamp by a second axle. The second axle extends widthwise across the kneeboard. The kneeboard further includes a light emitting diode for lighting a top surface of the top member. The light emitting diode is removable and has a flexible neck for lighting a top surface of the top member or other areas where a light is needed.

In an exemplary embodiment of the present invention, the bottom member has a concave bottom surface.

In an exemplary embodiment of the present invention, the straps are of an elastic fabric material and include a storage pouch for storing notes and fabric loops for storing additional writing instruments or pilot tools.

In an exemplary embodiment of the present invention, the kneeboard further includes a latch connecting the top member to the bottom member.

In an exemplary embodiment of the present invention, the kneeboard further includes a display attached to the tiltable surface.

In an exemplary embodiment of the present invention, the display includes a processor and a memory operably coupled to the processor, The memory has program instructions stored therein. The processor is operable to execute the program instructions. The program instructions include instructions for implementing a brownout/obscured landing system that receives data indicating aircraft position, displays a three dimensional perspective grid on the display, and moves the grid on the display in response to the aircraft position.

A method for providing a military moving map system on an interactive display is provided. Maps and geographically referenced overlays are stored. One of the maps and geographically referenced overlays is displayed. Said maps are stitched together at a same scale and map overlaps are trimmed to reduce blur. Aircraft latitude and longitude information is received through a Global Positioning System. Aircraft heading information is received through a compass or a gyrocompass. Aircraft position is displayed on said one of the maps and geographically referenced overlays using the aircraft latitude and longitude information. Aircraft direction and aircraft ground speed are determined by determining a change in the aircraft latitude and longitude information. The aircraft direction is displayed on the interactive display. The aircraft ground speed is displayed on the interactive display. The aircraft heading is displayed on the interactive display. A user is allowed to zoom into or out of said one of the maps and geographically referenced overlays. The user is allowed to change the maps and geographically referenced overlays for display. The user is allowed to mark locations on the maps through the interactive display. The user is allowed to pan maps that have been stitched together. The user is allowed to center the maps on a current geo-location reference after panning. Features on the interactive display are displayed when needed. Features on the interactive display are removed when unused. The user is allowed to change data formats by touching data on the interactive display. The user is allowed to request a line be drawn on the interactive display. The line extends from a current position of an aircraft to another position. The user is allowed to create a route and a distance of the route is shown and fuel required to complete the route is shown. The user is allowed to display distance, heading, and fuel required between any to known points. The user is allowed to input data by breaking the data into logical segments. The user is allowed to display actual aircraft position on the interactive display. The user is allowed to display a track of an aircraft on the interactive display.

### BRIEF DESCRIPTION OF THE DRAWINGS

FIG. 1 is a perspective view of an aircraft pilot kneeboard according to an exemplary embodiment of the present invention.

FIG. 2 is another perspective view of the kneeboard according to an exemplary embodiment of the present invention.

FIG. 3 is a perspective view of the kneeboard showing an internal compartment according to an exemplary embodiment of the present invention.

FIG. 4 is a perspective view of the kneeboard depicting the interactive screen/personal digital assistant (PDA) in a closed position according to an exemplary embodiment of the present invention.

FIG. 5 is another perspective view of the kneeboard depicting the interactive screen/PDA in a closed position according to an exemplary embodiment of the present invention.

FIG. 6 is a side perspective view of the kneeboard according to an exemplary embodiment of the present invention.

FIG. 7 is a side view of the kneeboard according to an exemplary embodiment of the present invention.

FIG. 8 is a top view of the kneeboard according to an exemplary embodiment of the present invention.

FIG. 9 is a rear perspective view of the kneeboard according to an exemplary embodiment of the present invention.

FIG. 10 is a front view of the kneeboard according to an exemplary embodiment of the present invention.

FIG. 11 is a perspective view of the kneeboard with the interactive screen/PDA depicting a map according to an exemplary embodiment of the present invention.

FIG. 12 is an example of a map provided by FalconView® mapping system.

FIG. 13 is another example of a map provided by FalconView® mapping system.

FIG. 14 is a screen shot of the start screen according to an exemplary embodiment of the present invention.

FIG. 15 is a screen shot of the main screen according to an exemplary embodiment of the present invention.

FIG. 16 is another screen shot of the main screen according to an exemplary embodiment of the present invention.

FIG. 17 is a screen shot of the main menu screen according to an exemplary embodiment of the present invention.

FIG. 18 is a screen shot of the tap screen according to an exemplary embodiment of the present invention.

FIG. 19 is a screen shot of the backlight setup screen according to an exemplary embodiment of the present invention.

FIG. 20 is a screen shot of the status screen according to an exemplary embodiment of the present invention.

FIG. 21 is a screen shot of the setup screen according to an exemplary embodiment of the present invention.

FIG. 22 is a screen shot of the tracks screen according to an exemplary embodiment of the present invention.

FIG. 23 is a screen shot of the local points screen according to an exemplary embodiment of the present invention.

FIG. 24 is a screen shot showing the add local points screen according to an exemplary embodiment of the present invention.

FIG. 25 is a screen shot of the local points edit screen according to an exemplary embodiment of the present invention.

FIG. 26 is a screen shot of the distance from-to screen according to an exemplary embodiment of the present invention.

FIG. 27 is a screen shot of the routes screen according to an exemplary embodiment of the present invention.

FIG. 28 is a screen shot showing the add/edit routes screen according to an exemplary embodiment of the present invention.

FIG. 29 is a perspective view of the kneeboard with the interactive screen/PDA depicting a brownout/obscured landing system according to an exemplary embodiment of the present invention.

FIG. 30 is a screen shot of a brownout/obscured landing system according to an exemplary embodiment of the present invention.

FIG. 31 depicts the kneeboard attached to a pilot's leg.

FIG. 32 is a block diagram of a conventional PDA.

FIG. 33 is a block diagram depicting a software flow of available screens for the kneeboard according to an exemplary embodiment of the present invention.

FIG. 34 depicts an example of a landing sequence utilizing the brownout/obscured landing system according to an exemplary embodiment of the present invention.

### DETAILED DESCRIPTION

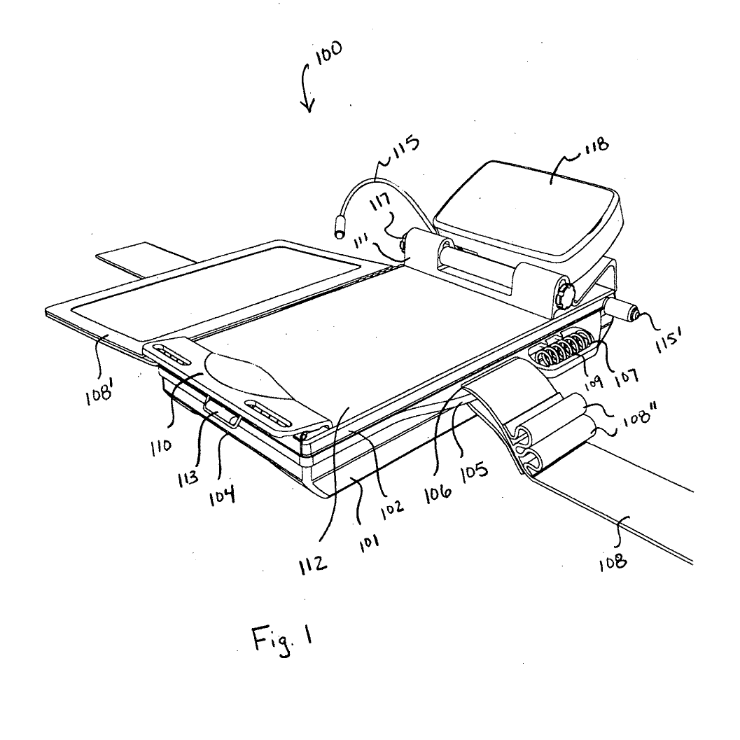

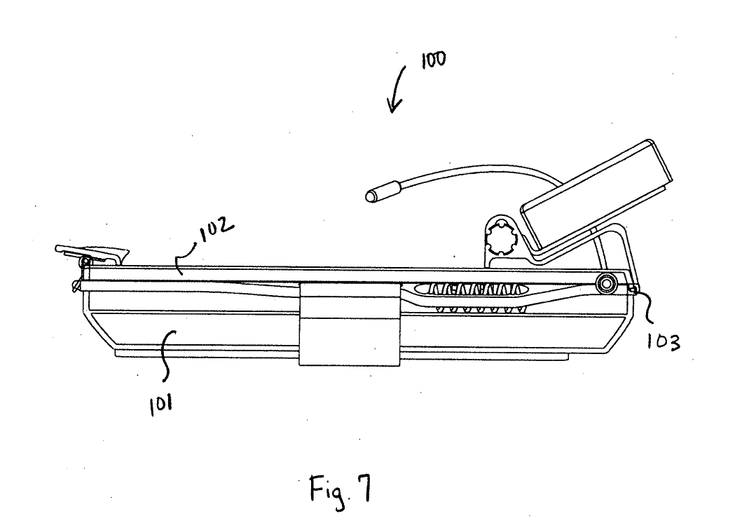

FIG. 1 is a perspective view of an aircraft pilot kneeboard 100 according to an exemplary embodiment of the present invention. The kneeboard 100 includes a bottom member 101 connected to a top member 102 at axle 103 (see FIG. 7). In an exemplary embodiment, axle 103 is a small piano pin. The kneeboard 100 is designed to be worn on a pilot's leg while piloting an aircraft and therefore the bottom member 101 includes a concave bottom surface 104 for fitting comfortably onto a pilot's leg. The bottom member 101 has flanges 105 that extend outwardly from the bottom member 101. The flanges 105 each have a slot 106 for the attachment of leg straps 108 and a slot 107 for placement of a spring pen holder 109. The leg straps 108 are of an elastic fabric material and may include an additional hinged flexible storage pouch 108′ and additional storage 108″ formed by the fabric for storing additional writing instruments or other pilot tools. The flexible storage pouch 108′ stores pilot's lists and additional plans/notes and can be moved to the left or right strap 108. The pouch is hinged so that it can be lifted away from the leg and viewed.

The spring pen holders 109 are compression springs located in the slots 107 with turns that are distanced slightly less than a diameter of a writing instrument. The left and right-handed spring pen holders 109 hold pens or other writing instruments extending upwardly from the top member 102 for easy access by the pilot. The top member 102 includes clamps 110, 111 for holding a pad of paper securely on a top surface 112 of the top member 102. The clamps 110, 111 are located on lower and upper top surfaces, respectively, of the top member 102 and are spring loaded to be biased in contact with the top surface 112 of the top member 102.

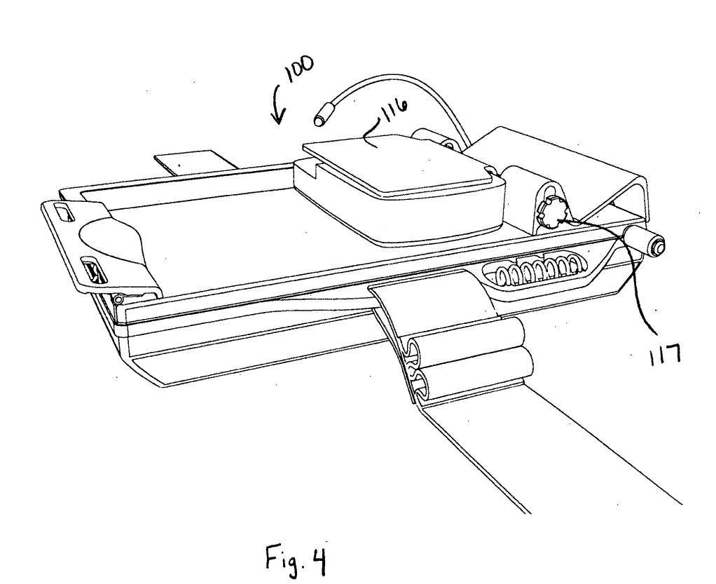

The kneeboard 100 further includes a latch 113 for locking the top member 102 and the bottom member 101 together. In addition, the kneeboard includes a removable and flexible light-emitting diode (LED) 115 for illuminating notes or maps clamped to the top surface 112 of the top member 102. The LED 115 does not interfere with night vision goggles. The LED 115 includes a knob 115′ at a bottom end for turning the LED on and off. Furthermore, the kneeboard 100 includes an adjustable and tiltable surface 116 (shown in FIG. 4) for attaching an interactive screen/PDA 118. The adjustable/tiltable surface 116 rotates about axis 117 so that the viewing angle of an attached interactive screen/PDA 118 may be optimized.

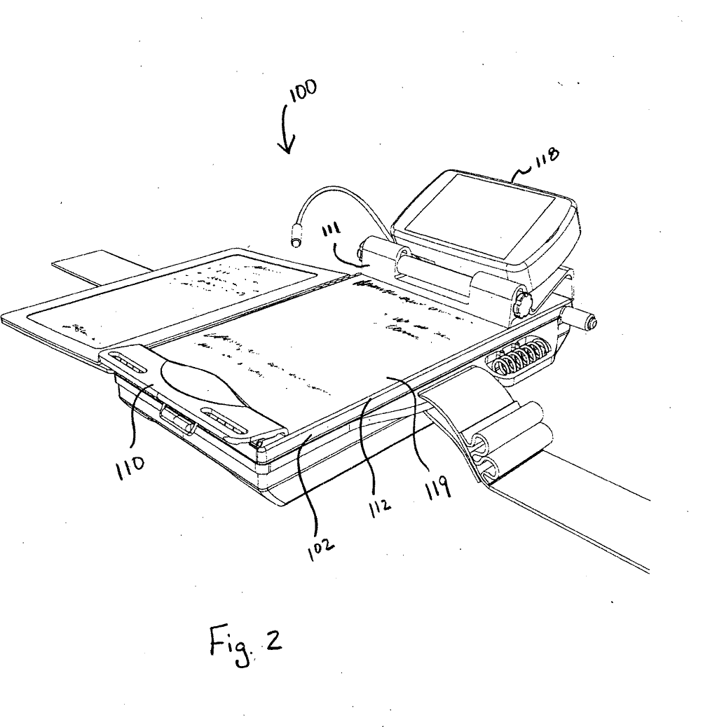

FIG. 2 is another perspective view of the kneeboard 100 according to an exemplary embodiment of the present invention. As depicted in FIG. 2, a note pad 119 may be secured to the top surface 112 of the top member 102 by lower clamp 110 and upper clamp 111. In an exemplary embodiment, the top member 102 may include a touchscreen flush with the top surface 112 (in addition to the PDA 118), which would allow a pilot to write notes on the touchscreen itself.

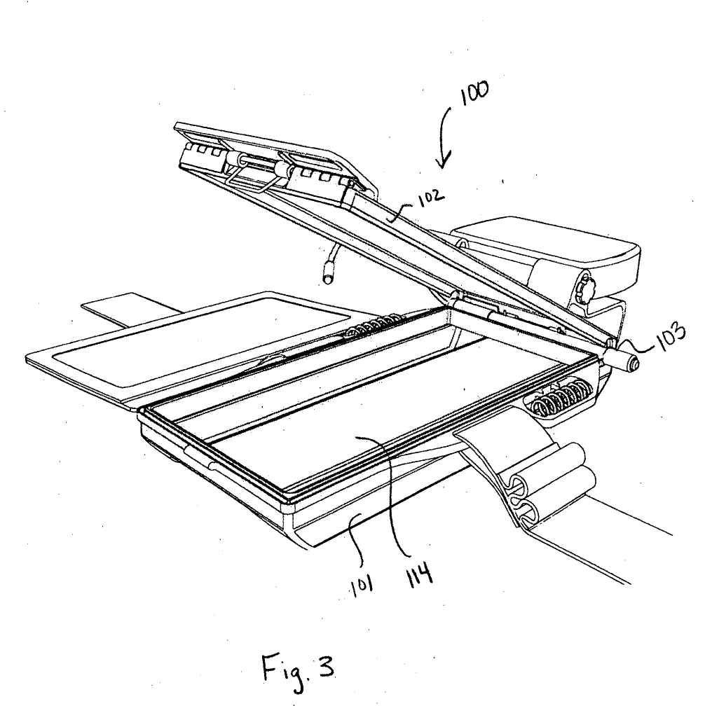

FIG. 3 is a perspective view of the kneeboard 100 showing an internal compartment 114 according to an exemplary embodiment of the present invention. Rotating the top member 102 about axle 103 reveals an inner compartment 114 within the bottom member 101. The inner compartment 114 can store writing instruments, batteries, a GPS device, a multifunction tool, or anything else a pilot may find necessary to bring on a flight.

FIG. 4 is a perspective view of the kneeboard 100 depicting the interactive screen/PDA 118 in a closed position according to an exemplary embodiment of the present invention. The interactive screen/PDA 118 is attached to the tiltable surface 116. The tiltable surface 116 is attached to axle 117. In an exemplary embodiment, the axle 117 has a plurality of positions and the axle 117 clicks into each of the plurality of positions upon application of a rotational force on the tiltable surface 116. In an alternative embodiment, a rotational type left/right, up/down system can be incorporated for positioning of the interactive screen/PDA 118 (e.g., that used for a car rearview mirror).

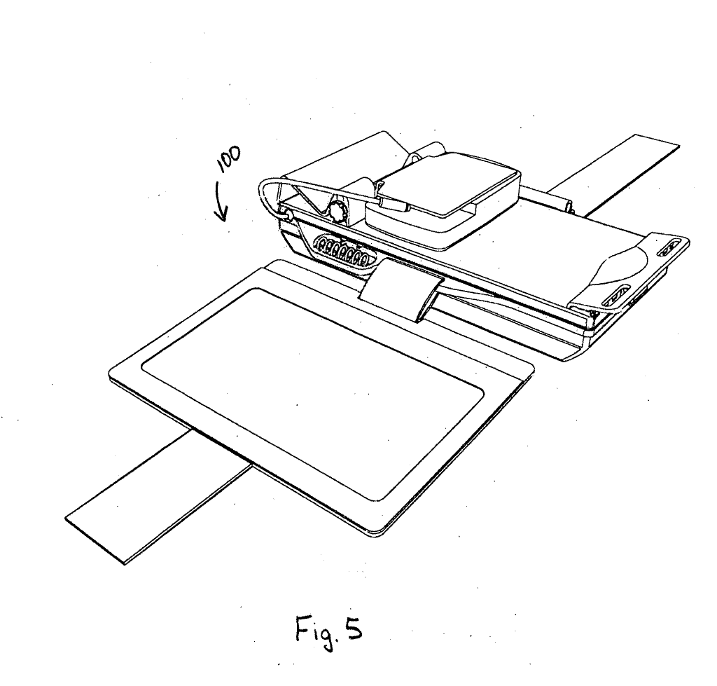

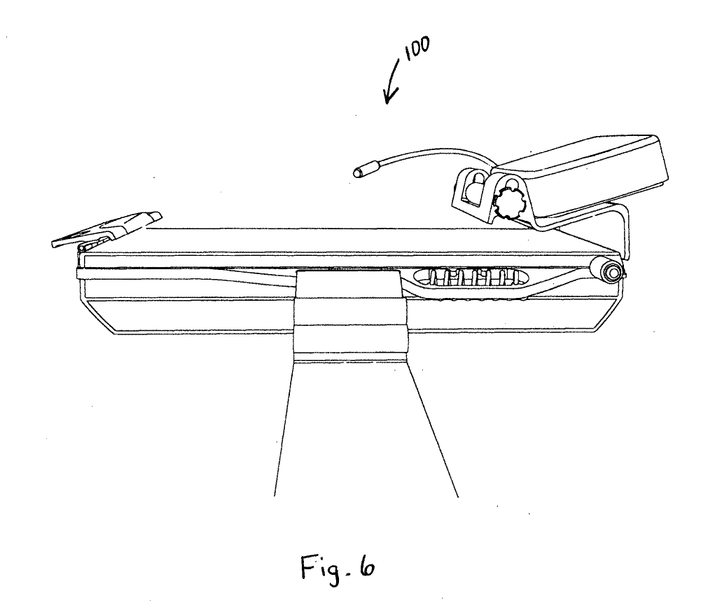

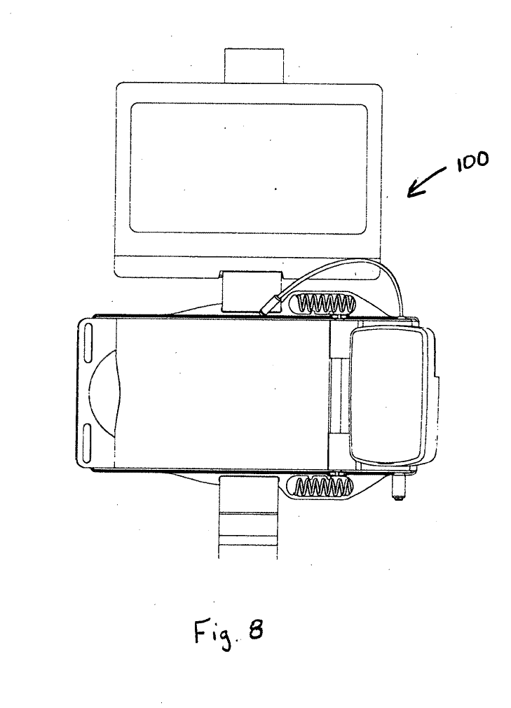

FIG. 5 is another perspective view of the kneeboard 100 depicting the interactive screen/PDA 118 in a closed position according to an exemplary embodiment of the present invention. FIG. 6 is a side perspective view of the kneeboard 100 according to an exemplary embodiment of the present invention. FIG. 7 is another side perspective view of the kneeboard 100 according to an exemplary embodiment of the present invention. The top member 102 rotates away from the bottom member 101 at axle 103. FIG. 8 is a top perspective view of the kneeboard 100 according to an exemplary embodiment of the present invention.

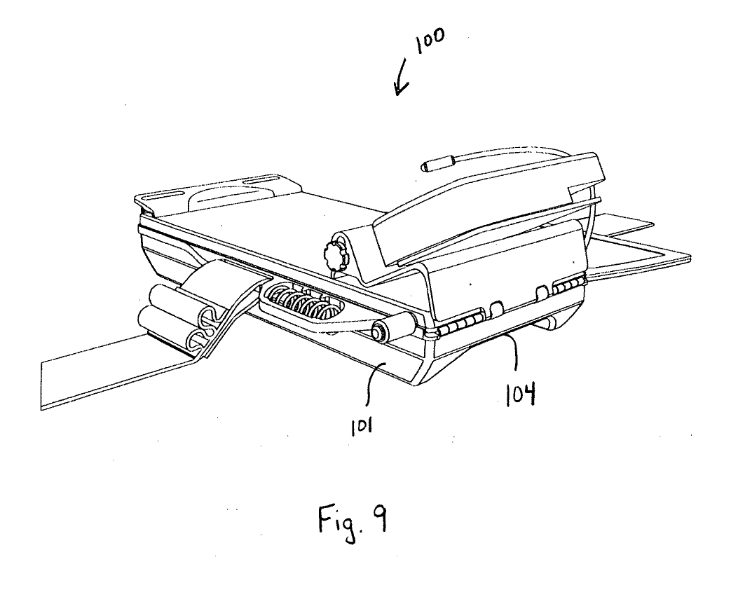

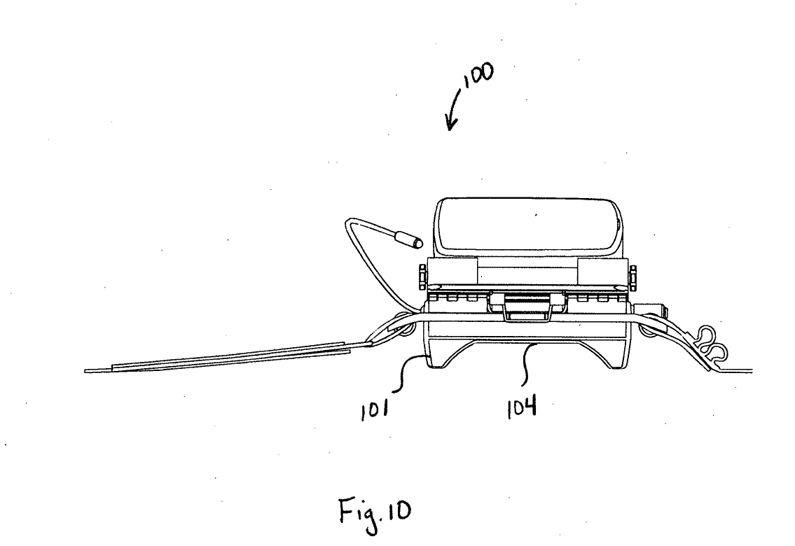

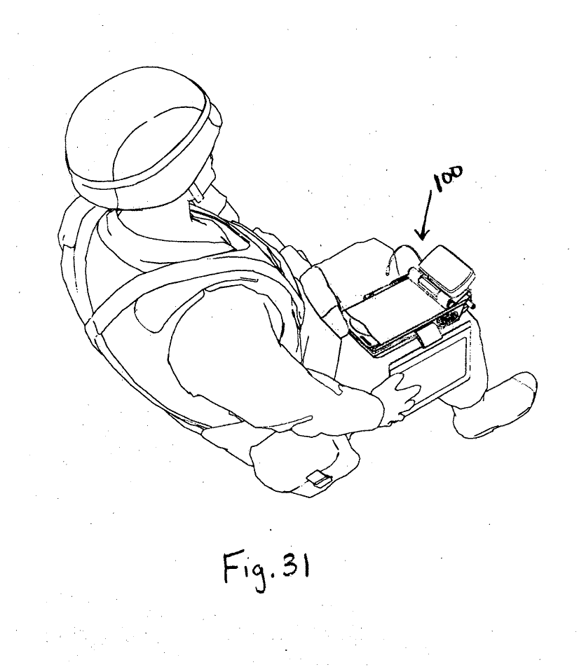

FIG. 9 is a rear perspective view of the kneeboard 100 according to an exemplary embodiment of the present invention. FIG. 10 is a front perspective view of the kneeboard 100 according to an exemplary embodiment of the present invention. As depicted in FIG. 9 and FIG. 10, the bottom member 101 has a concave bottom surface 104. The concave bottom surface 104 is shaped such that the kneeboard 100 fits comfortably onto a pilot's leg as depicted in FIG. 31. In an alternative embodiment, the concave bottom surface 104 has a narrower curvature for fitting comfortably on a forearm. In such an embodiment, the interactive screen/PDA 118 may be rotated 90°.

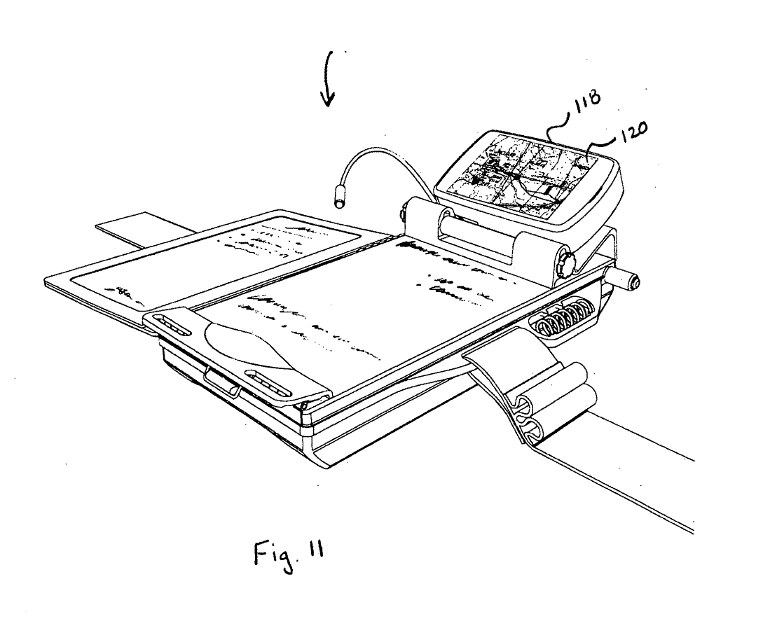

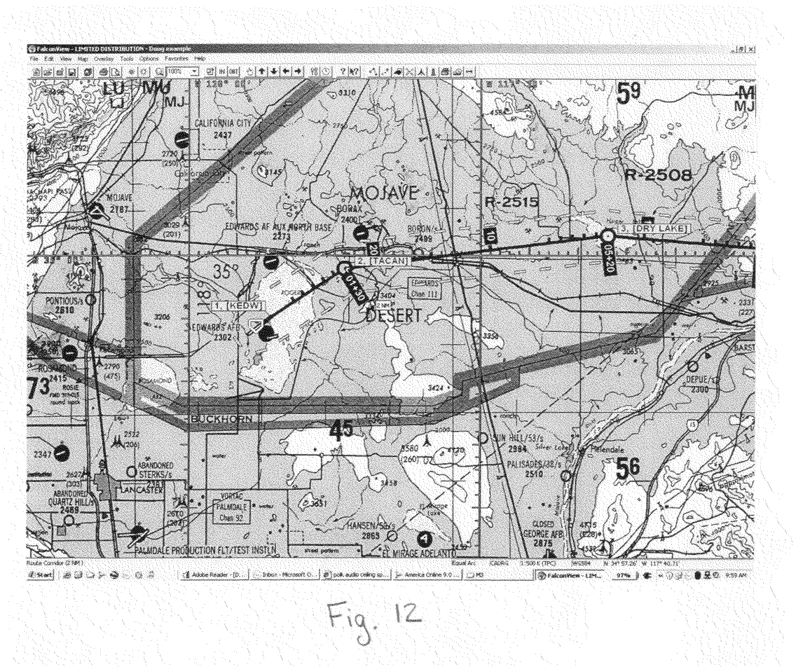

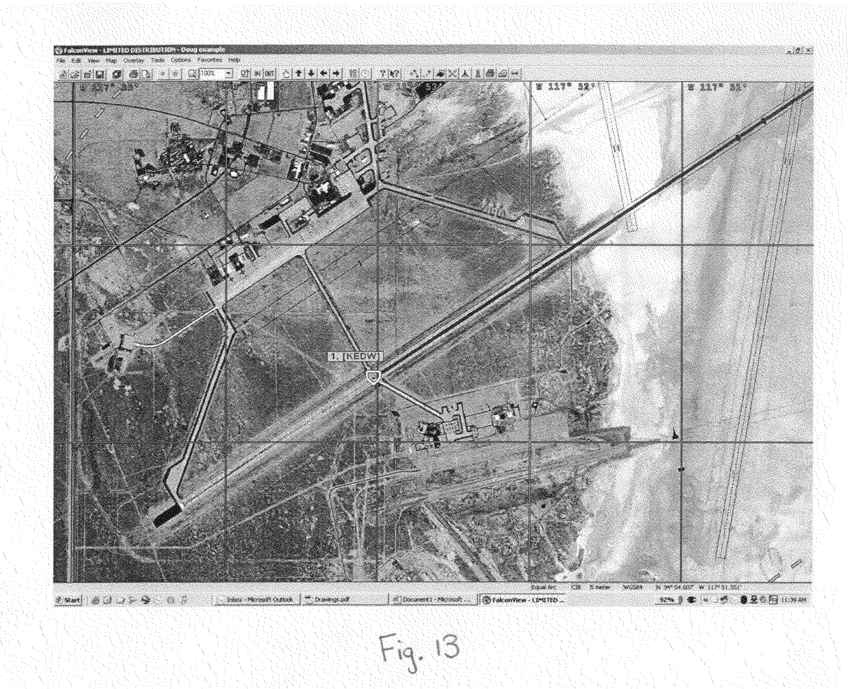

FIG. 11 is a perspective view of the kneeboard 100 with the interactive screen/PDA 118 depicting a map 120 according to an exemplary embodiment of the present invention. According to exemplary embodiments of the present invention, the interactive screen/PDA 118 provides an electronic moving map 120 for an increased level of situational awareness. The electronic moving map 120 are mapping data and overlays. The mapping data and overlays may be in any format. In an exemplary embodiment of the present invention, the mapping data and overlays are saved in GEO Tiff format from a military flight planning software called FalconView®/JUMPS mapping system. FalconView® mapping system displays various types of maps and geographically referenced overlays, typically aeronautical charts, satellite images, and elevation maps. FalconView® mapping system is currently part of an integrating suite of mission planning tools available in the Portable Flight Planning Software (PFPS) made available by the U.S. Army. FIG. 12 and FIG. 13 are examples of maps provided by FalconView® mapping system.

The moving map software provides an interactive and GPS linked moving map that gives a pilot a situational awareness with real-time positioning and other valuable information while flying. The moving map software is designed to interact with the saved GEO Tiff files and overlays that come from PFPS and FalconView®/JUMPS mapping system or other such planning software where maps can be saved as GEO Tiff files. Because the selected overlays are saved, the software provides a pilot with a unique view of the plan electronically with positioning information while flying. The moving map software displays actual mapping data and created flight plans with all of the FalconView®/JUMPS mapping system displayable attributes allowing the pilot to have a unique perspective of his position in real-time in relation to an actual plan.

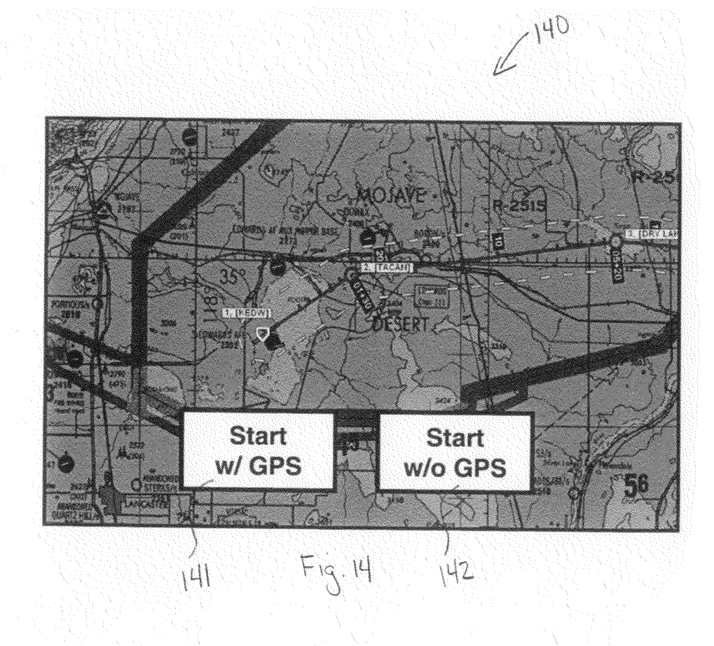

FIG. 14 is a screen shot of the start screen 140 according to an exemplary embodiment of the present invention. As depicted in FIG. 14, the interactive screen/PDA 118 has a simple touch screen interface for viewing the electronic moving map 120. The start screen 140 includes touch options for starting the moving map software program on the PDA 118 with GPS 141 or without GPS 142. As discussed above, a GPS device may be stored in the inner compartment 114 of the kneeboard. Such a device may communicate GPS data to the PDA 118 using Bluetooth® wireless technology, thus allowing the moving map software to utilize the GPS data. Bluetooth® is a registered trademark of Bluetooth SIG, Inc.

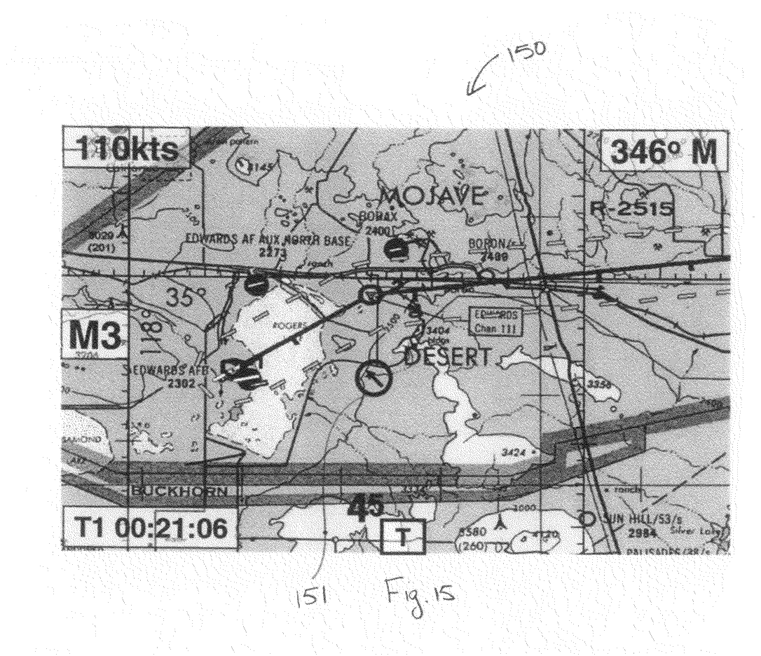

FIG. 15 is a screen shot of the main screen 150 according to an exemplary embodiment of the present invention. In the main screen 150, position is indicated by the center of the circle 151 with an integrated directional arrow as visual heading reference. Because the checkpoints and routes are created in the preflight plan in FalconView®/JUMPS mapping system, the main screen 150 provides a pilot with an instant situational awareness.

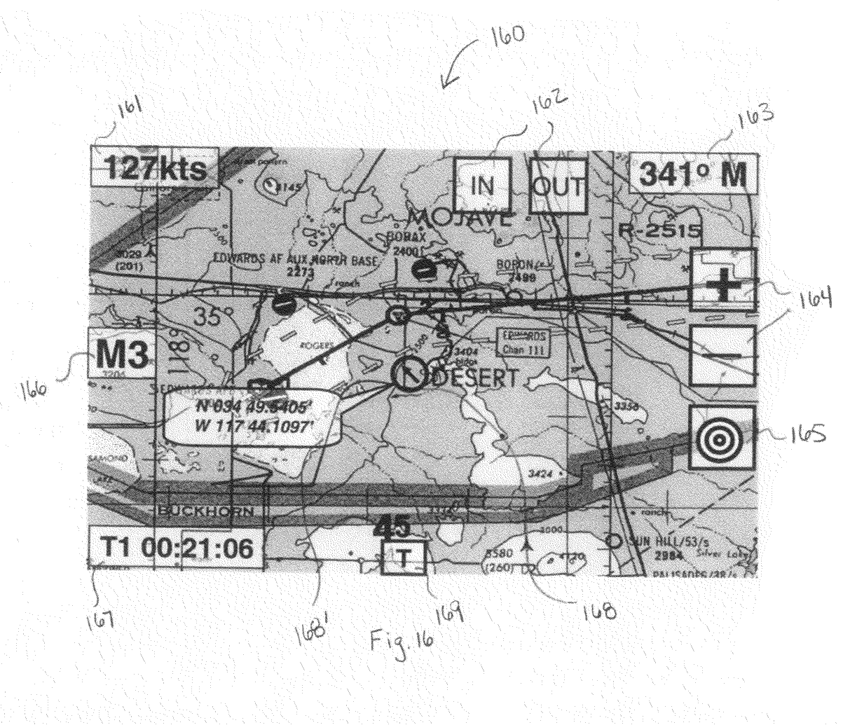

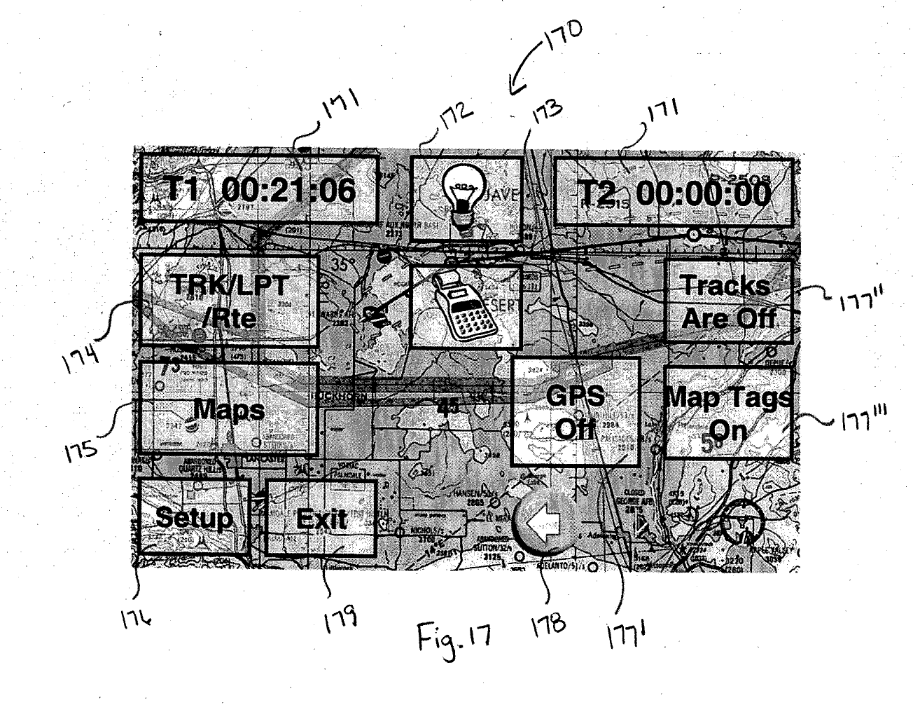

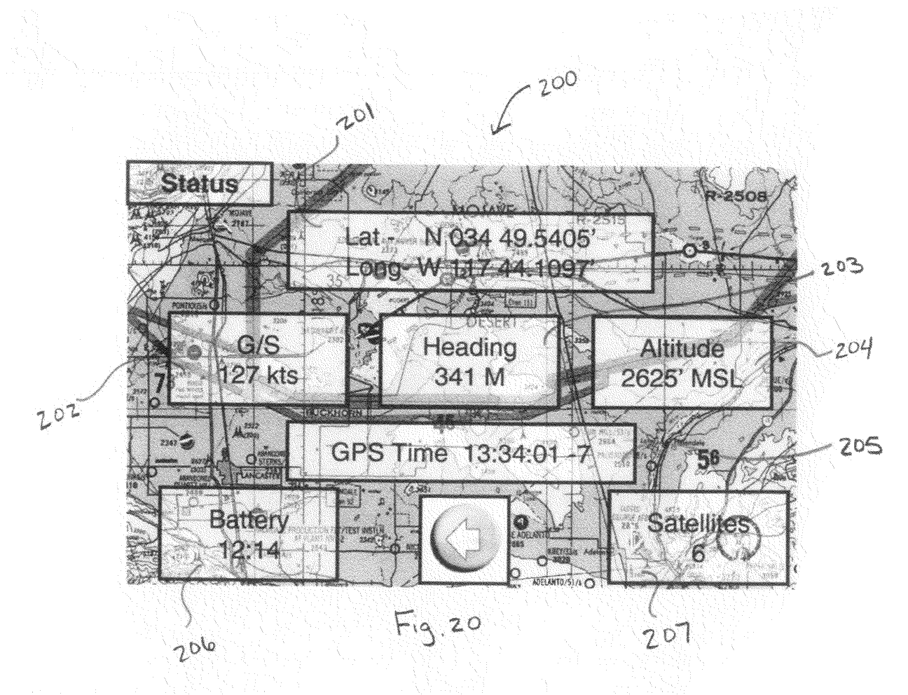

FIG. 16 is another screen shot of the main screen 160 according to an exemplary embodiment of the present invention. The main screen 160 displays aircraft ground speed in a screen tag 161 in the upper left corner. Tapping the upper left corner in an area corresponding to the area of the screen tag 161 toggles to and from the status screen 200 (see FIG. 20). Tapping the In and Out icons 162 changes the map to a map with a different scale if maps with different scales were saved via PFPS/FalconView® mapping system. For example, if 1:250, 1:500, and 1:1000 scaled maps are stored for access by the moving map software program, the pilot may change between these maps by tapping the In and Out icons 162. The main screen 160 displays heading in Magnetic or True degrees in a screen tag 163 in the upper right corner. Tapping the upper right corner in an area corresponding to the area of the screen tag 163 hides or shows the icons 162, 164, 165. That is, if the icons 162, 164, 165 are showing, tapping the upper right corner hides the icons, and if the icons 162, 164, 165 are hidden, tapping the upper right corner shows the icons. Alternatively, the icons 162, 164, 165 may be shown by panning the main screen 160. Tapping icons 164 zooms in and out of the map currently displayed. Upon panning the main screen 160, the pilot can tap icon 165 to center the currently displayed map with respect to the pilot's location. Once a tapping action is taken, i.e., zoom, scale, or center map, if no further tapping is done within 10 seconds the displayed icon will return to their hidden state. Otherwise icons stay visible until the pilot manually toggles the icons off by selecting the top right corner reference position. The M3 icon 166 brings up the main menu screen 170 (see FIG. 17), which provides access to various features that include the two timers; display brightness setting; a calculator; tracks, local points, and routes; maps; setup settings; and toggling on and off track, GPS, and map tags.

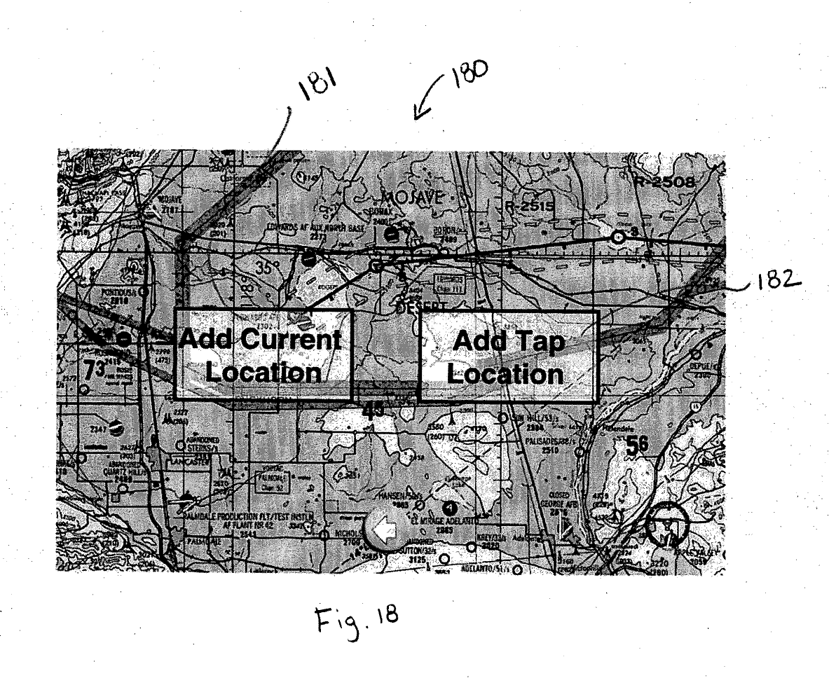

The main screen 160 further includes a timer screen tag 167 located in the bottom left or right corner. An additional timer may be revealed and utilized in the bottom right corner of the main screen 160. The timers allow for starting, stopping, and resetting in any sequence. Tapping “T1/T2” position resets the timer and tapping the timer digits starts and stops the timer. Once activated the timers will remain on the main screen as long as the timers are displaying information. The timers will return to their hidden state after 10 seconds of being stopped and reset to zero. In addition, the main screen 160 includes circle 168. Tapping the circle 168 displays the pilot's current position 168′ in latitude and longitude, Universal Transverse Mercator (UTM), or Military Grid Reference System (MGRS) formats. The pilot may select which of these formats to display via the Status Screen by tapping on the appropriate icon. Finally, the main screen 160 includes the “T” icon 169, which turns on and off a tap point feature. When the tap point feature is on, the “T” icon 169 is displayed in green. When the tap point feature is off, the “T” icon 169 is displayed in red. When the tap point feature is on (i.e., the “T” icon 169 is green), a pilot may tap the main screen 160 in locations other than the icons and screen tag locations described above to access the tap screen 180 (see FIG. 18). The tap screen 180 allows a pilot to record coordinates for the current position or a designated/selected position.

Although the main screen 160 is depicted with screen tags 161, 163 displaying aircraft ground speed and heading, the screen tags 161, 163 may display other information such as GPS time, current location, and battery life, as well as being toggled on and off of the main screen from the main menu screen 170.

FIG. 17 is a screen shot of the main menu screen 170 according to an exemplary embodiment of the present invention. The main menu screen 170 is accessed by tapping the M3 icon 166. The main menu screen 170 displays icons for the two timers 171; display brightness setting 172; a calculator 173; tracks, local points, and routes 174; maps 175; setup/settings 176; and toggling on and off GPS 177′, track 177″, and map tags 177″′. The main menu screen 170 further includes return icon 178 for returning to the main screen 160 and exit icon 179 for exiting the program.

The maps icon 175 accesses a reference library of all the GEO Tiff maps saved on the memory storage device from FalconView®/JUMPS mapping system. The pilot saves these maps and overlays created in FalconView®/JUMPS mapping system to a memory storage device (i.e., Secure Digital card) that works with the portable computing device. These map/overlay files can be automatically accessed by turning on the software with GPS (i.e., tapping the “w/GPS” icon 141 on the start screen 140). The maps/overlays will indicate the pilot's position by displaying a small circle (i.e., 151 in FIG. 15 and 168 in FIG. 16) with an integrated direction arrow. The arrow displays the aircraft's direction of movement. If the device is turned on without the GPS (i.e., tapping the “w/o GPS” icon 142 on the start screen 140), the pilot can access the maps individually for review purposes. The maps are saved like puzzle pieces with different layers for the different scale maps. The software has a unique feature of stitching together the pieces. The maps appear to be contiguous when displayed.

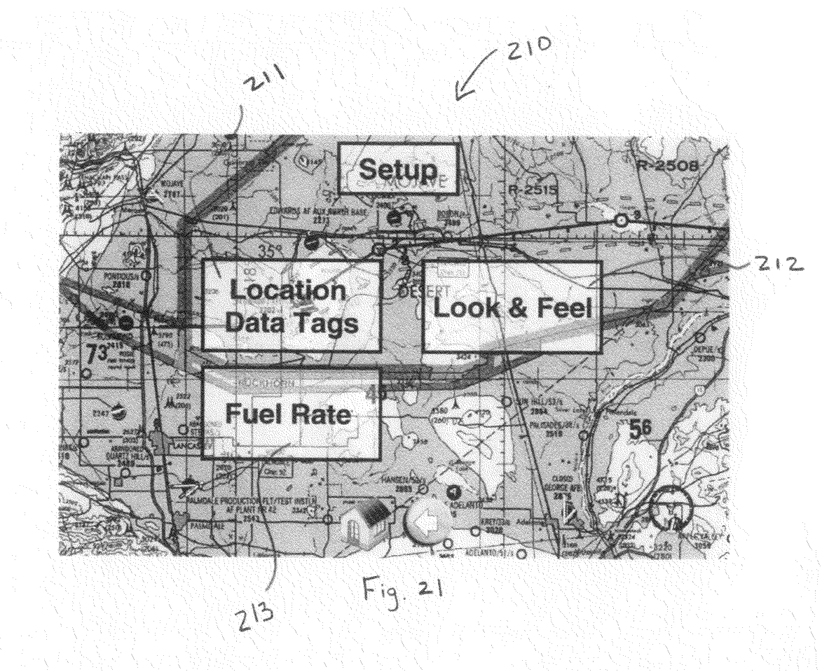

The setup/settings icon 176 brings up the status screen 210 (see FIG. 21), which allows the pilot to set basic features such as look and feel, which include transparency of the menus, display tag location; fuel rate/pounds per hour and airspeed flown, which establish calculations used by the “from-to” and “route time/distance” features; and other color and size features.

The GPS On/Off icon 177′ allows the GPS to be turned on/off from within the program. The tracks on/off icon 177″ allows for the turning on/off of the “bread crumbs” feature displaying current or previous flight path on the main screen 160. The map tag on/off icon 177″′ allows for toggling the tags 161, 163 on/off of the main screen 160.

FIG. 18 is a screen shot of the tap screen 180 according to an exemplary embodiment of the present invention. The tap screen 180 is accessed by tapping the main screen 160 while the “T” icon is green. The tap screen 180 includes icons 181 for adding a current location, icon 182 for adding a tapped location, and icon 183 for returning to the map screen 160.

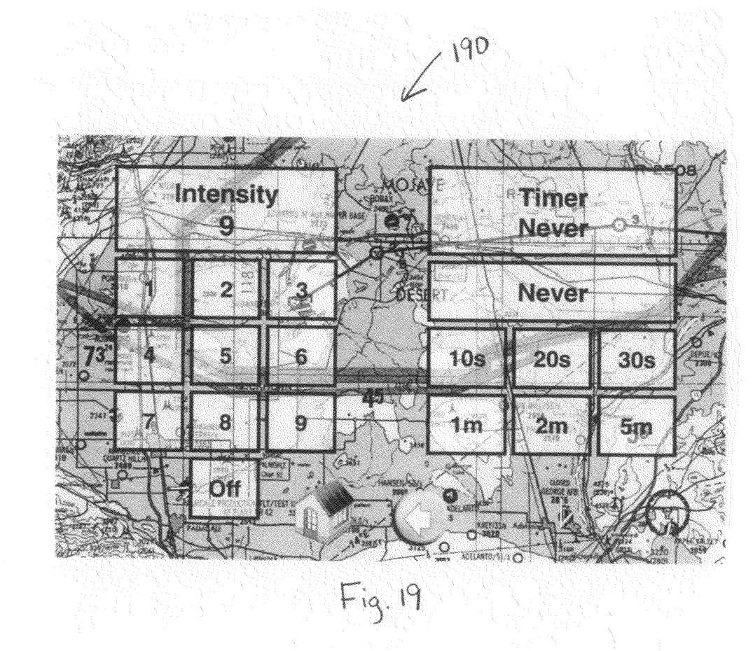

FIG. 19 is a screen shot of the backlight setup screen 190 according to an exemplary embodiment of the present invention. The backlight setup screen 190 allows for the intensity of the backlight to be adjusted and for timer parameters to be changed.

FIG. 20 is a screen shot of the status screen 200 according to an exemplary embodiment of the present invention. The status screen 200 displays icons for current position 201 in latitude and longitude, Universal Transverse Mercator (UTM), or Military Grid Reference System (MGRS) formats; ground speed 202 in knots, miles per hour, or kilometers per hour; a heading 203 that shows aircraft direction over the ground in Magnetic or True; altitude 204 in feet or meters; GPS time 205 adjustable to plus or minus two time zones; available battery life 206; and the number of satellites tracked by the GPS 207. Tapping the icons changes the displayed format/units measure for the various data.

FIG. 21 is a screen shot of the setup screen 210 according to an exemplary embodiment of the present invention. The setup screen 210 is accessed by selecting the setup icon 176 in the main menu screen 170. The setup screen 210 allows the pilot to change the location of data tags 211, the look and feel 212 of the screens, and to enter fuel settings 213.

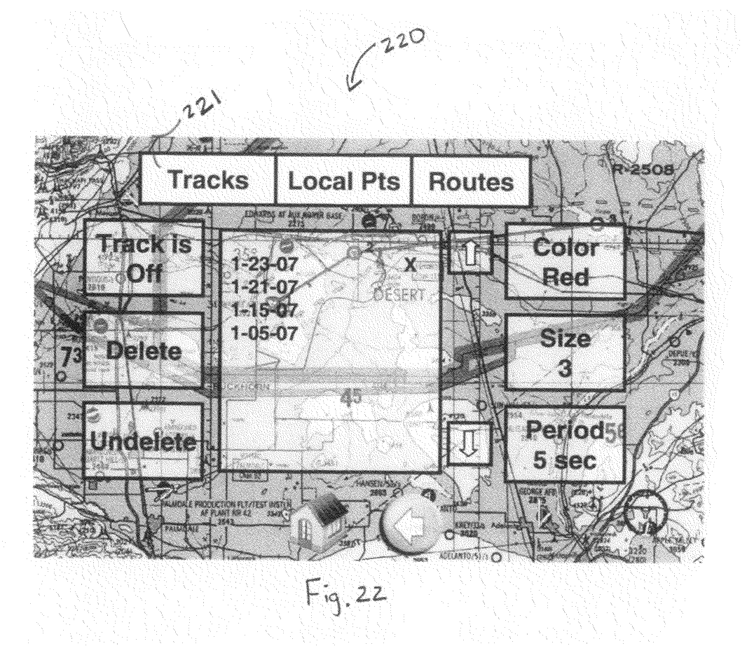

FIG. 22 is a screen shot of the tracks screen 220 according to an exemplary embodiment of the present invention. The tracks screen 220 is accessed by selecting the tracks icon 221 in the tracks, local points, and routes screen. The tracks, local points, and routes screen is accessed from the tracks, local points, and routes icon 174 in the main menu screen 170. The main menu screen 170 is accessed by selecting the M3 icon 166 in the main screen 160. The tracks screen 220 allows the pilot to see or to review his actual flight path by leaving a “bread crumb” every 2-30 seconds (adjustable). Displaying the flight path can be turned on or off, but the file is always saved for later viewing regardless whether this feature is on or off.

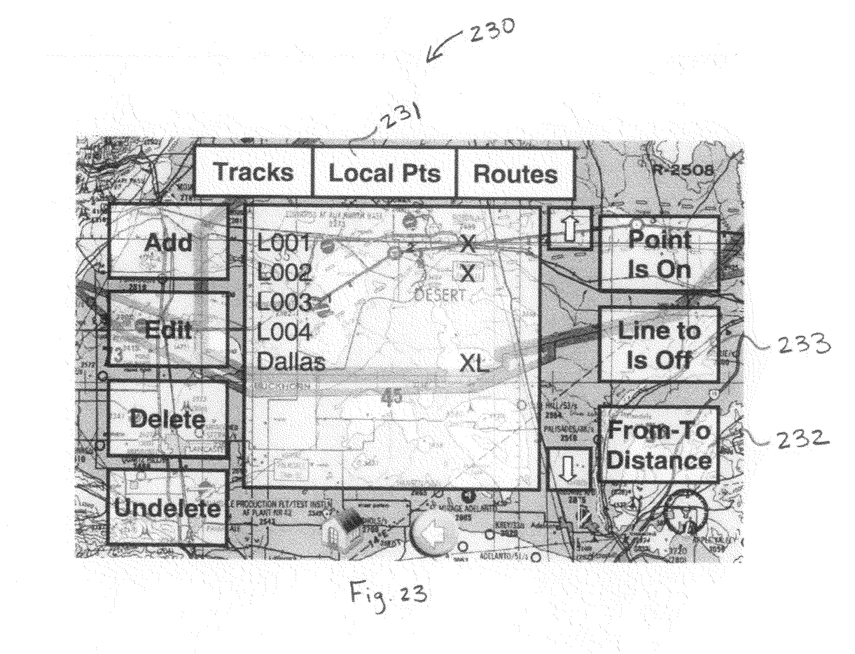

FIG. 23 is a screen shot of the local points screen 230 according to an exemplary embodiment of the present invention. The local points screen 230 is accessed by selecting the local points icon 231 in the tracks, local points, and routes screen. The tracks, local points, and routes screen is accessed from the tracks, local points, and routes icon 174 in the main menu screen 170. The main menu screen 170 is accessed by selecting the M3 icon 166 in the main screen 160. The local points screen 230 allows the pilot to add predetermined points of interest for display such as check points, known enemy positions, friendly positions, forward operation bases, equipment position, etc. Local points can be added while flying via the tap feature on the main screen 160, add local point icon from the local points screen 230, or can be copied and loaded from the files in FalconView®/JUMPS mapping system. Local points can easily be displayed on the map or turned off based on the need of the pilot and the mission.

The local points screen 230 includes “line to” icon 233 and “from to” icon 234. The “from to” feature accessed by icon 232 incorporates aircraft fuel burn and ground speed calculations to give real-time distance and fuel required to go from one position to another. The “line to” feature accessed by icon 233 shows the visual direction of a newly inputted or existing local point. Selecting the “line to” feature after highlighting a desired point displays a line from the aircraft's current position to a new position. The new position may or may not be located on an available map. The “line to” feature is useful especially when a new point is not located on the map being displayed and rerouting of the aircraft is required.

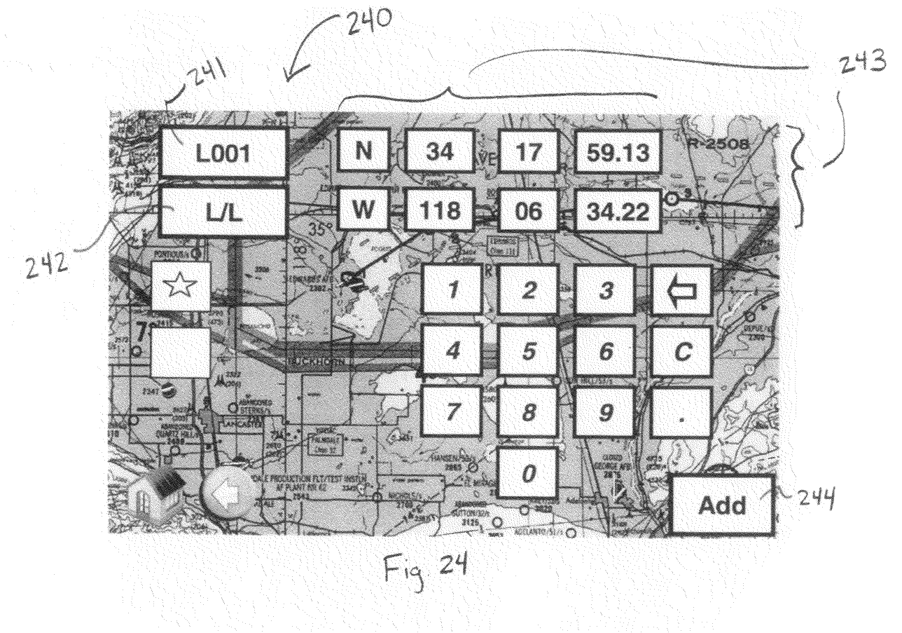

FIG. 24 is a screen shot showing the add local points screen 240 according to an exemplary embodiment of the present invention. Local points have a default sequential number for identifying each of the local points. Text entry 241 shows this number by default. Alternatively, the pilot can rename this local point to any name. Selecting text entry 241 brings up a QWERTY keyboard. Icon 242 displays the position format. Selecting icon 242 changes the position format between latitude and longitude, Universal Transverse Mercator (UTM), and Military Grid Reference System (MGRS) formats, which changes the text entries 243 to correspond with the particular selected format. The add icon 244 adds the local point and returns to the local points screen 230 displaying the point just added. The information is broken into easily editable pieces. Once information is input, the system automatically jumps to the next box to be input.

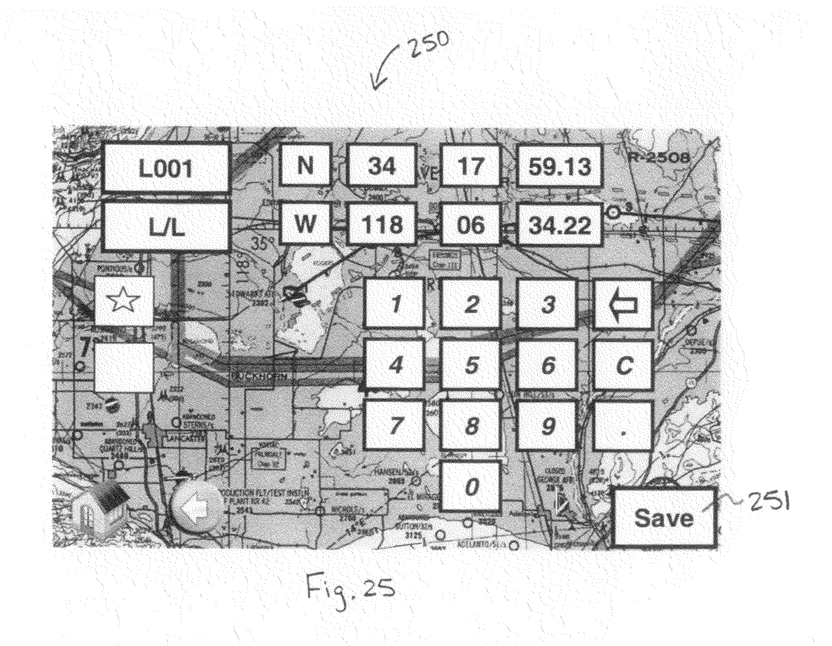

FIG. 25 is a screen shot of the local points edit screen 250 according to an exemplary embodiment of the present invention. The local points edit screen 250 allows for particular local points to be changed and then saved by selecting the save icon 251. Selecting the save icon 251 returns to the local points screen 230.

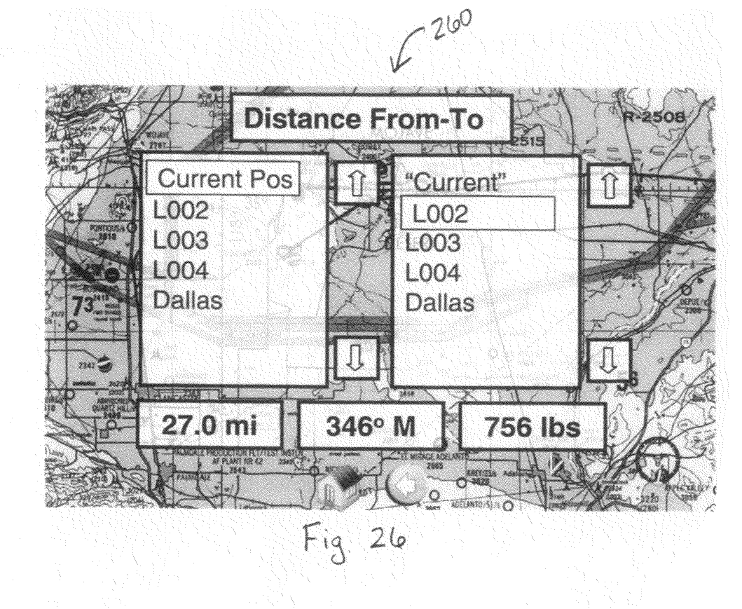

FIG. 26 is a screen shot of the distance from-to screen 260 according to an exemplary embodiment of the present invention. The distance from-to screen is accessed by selecting the “from-to” icon 232 in the local points screen and shows Distance, Heading and Fuel required between any to known points 230.

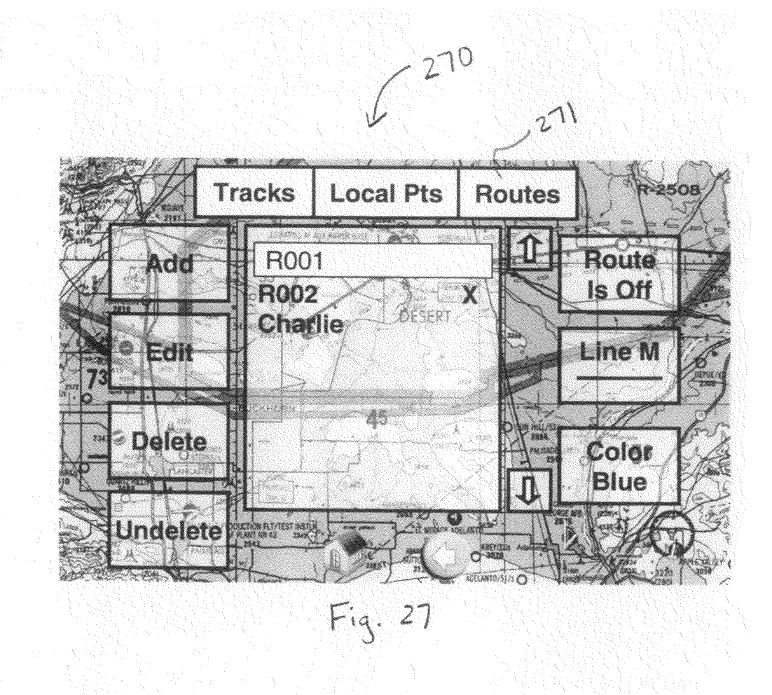

FIG. 27 is a screen shot of the routes screen 270 according to an exemplary embodiment of the present invention. The routes screen 270 is accessed by selecting the routes icon 271 in the tracks, local points, and routes screen. The tracks, local points, and routes screen is accessed from the tracks, local points, and routes icon 174 in the main menu screen 170. The main menu screen 170 is accessed by selecting the M3 icon 166 in the main screen 160. The routes screen 270 allows routes to be easily created from the library of local points in the add routes menu. Once a route is created, a unique feature shows length of route and fuel required. These settings are unique to each aircraft and can be adjusted in the fuel rate setting menu. Routes can be easily displayed on the main screen by toggling them on/off in the routes screen 270.

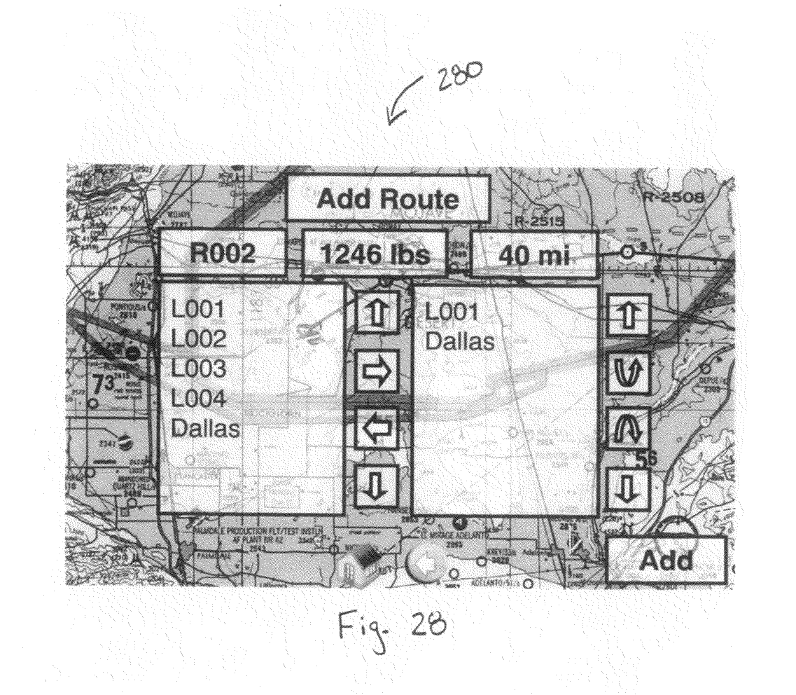

FIG. 28 is a screen shot showing the add/edit routes screen 280 according to an exemplary embodiment of the present invention.

As described above, the moving map software uses the actual mapping data and plan developed in PFPS/FalconView® mapping system with all of its detail. All mapping data is maintained and updated through National Imagery and Mapping Agency (NIMA) and squadrons get their update every month. This means there is no additional mapping data to maintain, simplifying implementation, execution. In addition, a pilot may save mapping images on a Secure Digital (SD) card and insert the SD card into a pocket PC/PDA. The pocket PC/PDA receives GPS data via a wireless Bluetooth® connection or integrated GPS, thus allowing the software to utilize the GPS data. Furthermore, the software allows for creation of a predetermined flight plan in the preflight planning phase via FalconView® mapping system or the ad hoc flight plan tools within the software if the mission changes while the pilot is piloting the aircraft.

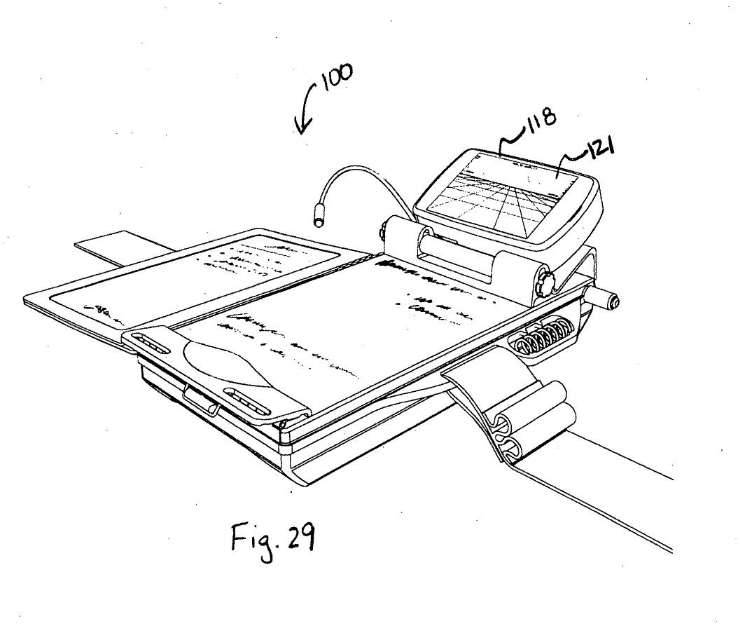

FIG. 29 is a perspective view of the kneeboard 100 with the interactive screen/PDA 118 depicting a brownout/obscured Landing System using a drift landing grid 121 according to an exemplary embodiment of the present invention. In addition to providing a moving map 120, the interactive screen/PDA 118 provides a simulation of a landing area overlaid with a drift landing grid 121 providing a near ground drift reference for aiding with landing in brownout/obscured conditions.

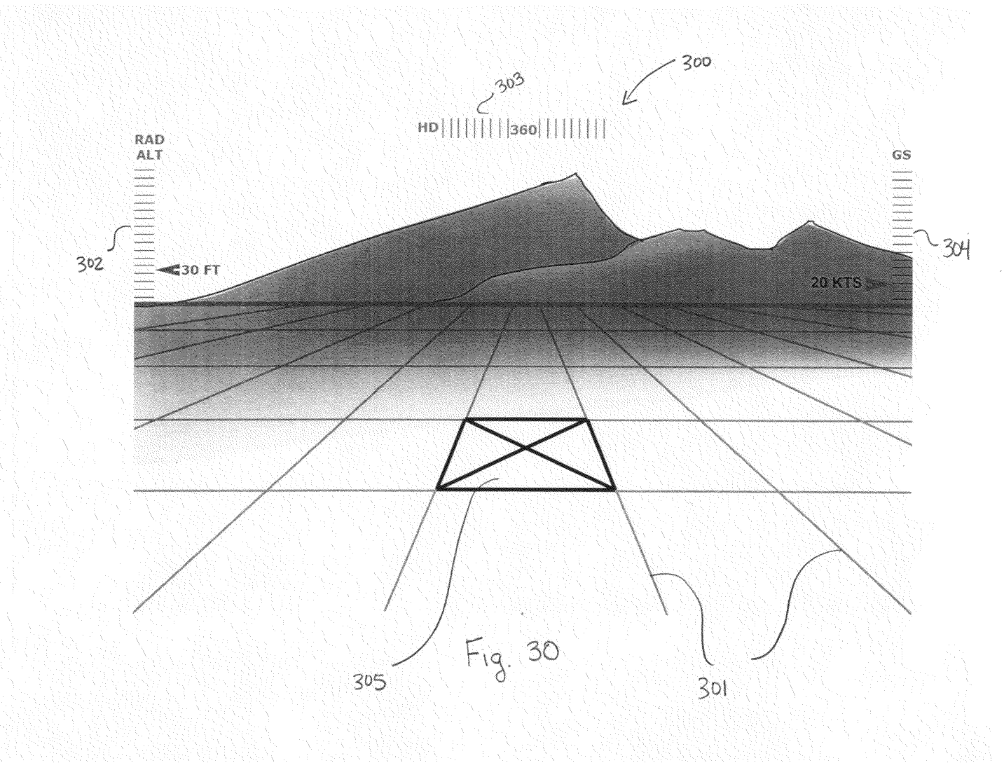

FIG. 30 is a screen shot of a brownout/obscured Landing System using a drift landing grid 300 according to an exemplary embodiment of the present invention. As a pilot lands, the pilot may observe the display showing a simulated landing environment, using overlaid grid 300 to show relational movement/drift so that the proper control input can be performed to minimize/stop the movement prior to landing. A drift reference can be provided by a Doppler radar, but Doppler radars are expensive and most helicopters are not equipped with this system. In conventional systems Doppler radar system are not used for landing but rather to perform hover operations over fixed positions when ground references are not able, e.g., as with continuous surfaces like the ocean or during rescue operation at night. Alternatively, for the landing environment in brownout/obscured conditions, drift may be provided by GPS and a Micro Inertial Measurement System (MIMS) gyro (i.e., a gyrocompass). A drift reference may also be provided by GPS and a compass incorporated with a visual simulation or actual video of the ground.

The interactive screen/PDA 118 receives the ground speed and direction data and provides a visual representation of drift with a perspective square landing grid 301. The perspective landing grid 301 is a 3D system which allow for a simulated view of landing that the pilot would normally have when landing visually. The landing grid gets larger as the aircraft nears the ground and shows the aircraft movement (forward, backward, left and right) in relation to the square grids overlaid on the surface. This gives the perspective that the pilot is used to seeing when landing. In an exemplary embodiment, each square in the landing grid 301 represents 10 square feet. In another exemplary embodiment, the perspective landing grid 301 is overlaid with geographical references, such a mountains, valleys, lakes, rivers, etc. The drift landing grid 300 may further display altitude 302, heading 303, and ground speed 304, and other needed flight references (not shown) such as, for example, RadAlt and VSI. In another exemplary embodiment, the drift landing grid 300 displays a landing spot 305 by highlighting one or more squares in the perspective landing grid 301.

As an aircraft approaches to land, the 3D perspective landing grid 301 provides a ground reference with which aircraft position may be compared. As an aircraft moves in relation to the ground, the perspective landing grid 301 also moves. In addition, as an aircraft drifts in position relative to the ground, the landing grid will correspondingly move in the opposite direction. Therefore, by observing the perspective landing grid 301, a pilot can determine whether the aircraft is drifting with respect to the ground, whether laterally or rotationally and make the proper control inputs to stop the movement of the aircraft prior to landing.

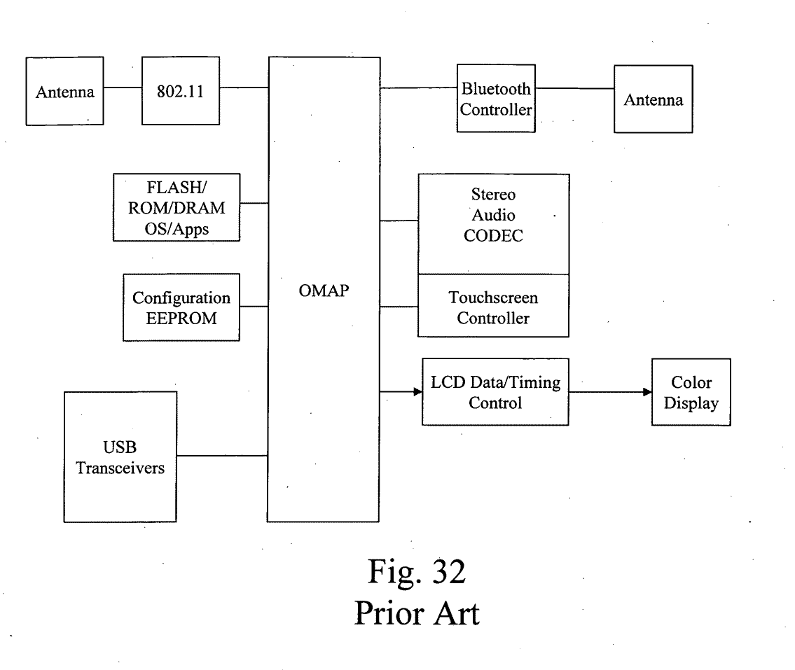

FIG. 32 is a block diagram 310 of a conventional PDA. The interactive screen/PDA 118 receives data indicating aircraft position via the antenna 311 connected to the Bluetooth® controller 312. The data indicating aircraft position is the aircraft's latitude and longitude received from the GPS. The PDA displays a three dimensional perspective grid on the display 313. In addition, in response to changing aircraft position, the processor 314 moves the grid on the display 313 corresponding to the aircraft position.

The data indicating aircraft position includes aircraft latitude and longitude information through the GPS, aircraft heading information through a compass or gyrocompass, aircraft altitude information, and aircraft attitude information.

In moving the grid, the processor 314 shifts the grid corresponding to the aircraft latitude and longitude information, rotates the grid along a surface of the grid corresponding to the aircraft heading information, resizes the grid corresponding to aircraft altitude information, and tilts the grid corresponding to aircraft attitude information.

The PDA may further display the grid overlaid with geographical references. In addition, the PDA may display aircraft heading information, aircraft altitude information, and aircraft ground speed information. The aircraft ground speed information may be determined by comparing the aircraft latitude and longitude information. Furthermore, the PDA may display a landing zone by highlighting or marking a section of the grid.

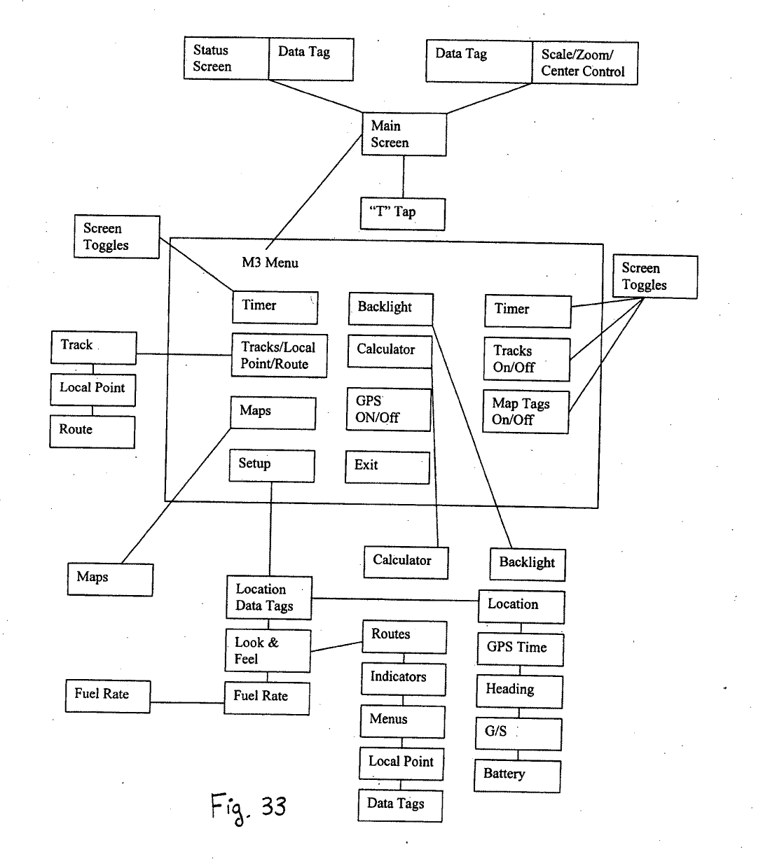

FIG. 33 is a block diagram depicting a software flow of available screens for the kneeboard according to an exemplary embodiment of the present invention. The software flow corresponds to the screen shots depicted in FIG. 14 through FIG. 28.

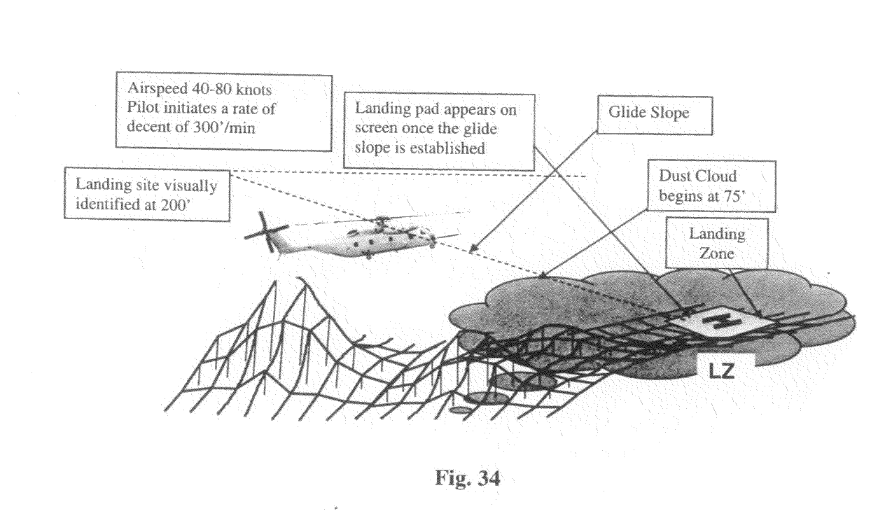

FIG. 34 depicts an example of a landing sequence utilizing the brownout/obscured landing system according to an exemplary embodiment of the present invention. The brownout/obscured landing system according to an exemplary embodiment of the present invention provides artificial visual references for landing in brownout/obscured conditions on a computing device display. The brownout/obscured landing system uses a 3D perspective view of the landing site and overlays a geo-referenced grid/checker board so that the pilot can have a visual references after entering the self induced dust cloud. A landing pad will automatically appear once the aircraft begins the landing sequence.

The pilot identifies the landing spot and establishes a visual reference, i.e., landing zone, adjacent trees, rocks, vehicles or other fixed features as the needed outside visual reference to target the landing. The pilot decides the best direction to approach the landing site and then initiates the landing sequence. The pilot reduces aircraft power and adjusts the aircraft nose attitude to set the required deceleration to maintain a controlled rate of descent which establishes a glide slope to the landing zone.

The pilot's intent is to arrive at the landing spot with 0 airspeed and 0 rate of descent. Because the landing site is lost in the dust cloud, there is a need for artificial visual landing references that use real electronic positioning data to assist the pilot in landing. The grid system/checker board overlay is used as a needed visual reference for assisting the pilot in minimizing the aircrafts movement when nearing the ground. The landing pad overlay would assist the pilot in landing to a specific spot. This landing spot would represent the same spot that the pilot visually identified at 200′ prior to entering the dust cloud.

Prior to entering the self induced dust cloud a landing site and glide slope has been established. A simple math calculation can be completed to project the landing pad based on the aircrafts rate of decent and decelerating airspeed. The calculation will project a landing pad to be overlaid on the geo-referenced grid system. The calculated landing pad will give the pilot the additional reference for landing the aircraft at the site visually selected when starting the landing sequence at 200′.

Additional external instruments possibly needed to derive needed calculations for a brownout/obscured landing may include an instrument grade accelerometer and a Calement filter.

While the invention has been described in terms of exemplary embodiments, it is to be understood that the words which have been used are words of description and not of limitation. As is understood by persons of ordinary skill in the art, a variety of modifications can be made without departing from the scope of the invention defined by the following claims, which should be given their fullest, fair scope.

What is claimed is:

1. A method for operating a brownout/obscured landing system, comprising:
receiving data indicating aircraft position;
displaying a three dimensional perspective grid on a display; and
moving the grid on the display in response to the aircraft position.

2. The method as claimed in claim 1, wherein receiving data indicating aircraft position includes:
receiving aircraft latitude and longitude information through a Global Positioning System;
receiving aircraft heading information;
receiving aircraft altitude information; and
receiving aircraft attitude information.

3. The method as claimed in claim 2, wherein moving the grid on the display includes:
shifting the grid corresponding to the aircraft latitude and longitude information;
rotating the grid along a surface of the grid corresponding to the aircraft heading information;
resizing the grid corresponding to aircraft altitude information; and
tilting the grid corresponding to aircraft attitude information.

4. The method as claimed in claim 1, further comprising:
displaying the grid overlaid with geographical references.

5. The method as claimed in claim 2, further comprising:
displaying the aircraft heading information;
displaying the aircraft altitude information; and
displaying aircraft ground speed information, the aircraft ground speed information determined by comparing the aircraft latitude and longitude information.

6. The method as claimed in claim 1, further comprising:
allowing a user to preprogram a landing zone; and
displaying the landing zone by highlighting or marking a section of the grid.

7. The method as claimed in claim 1, further comprising:
calculating a landing zone by projection based on a rate of decent and a decelerating airspeed; and
displaying the landing zone by highlighting or marking a section of the grid.

8. The method as claimed in claim 1, further comprising:
allowing a user to preprogram a first landing zone;
calculating a second landing zone by projection based on aircraft movement;
displaying the first landing zone by highlighting or marking a corresponding section of the grid; and
displaying the second landing zone by highlighting or marking a corresponding section of the grid.

9. A method for operating a brownout/obscured landing system, comprising:
receiving data indicating aircraft position, the data including aircraft latitude and longitude information received through a Global Positioning System, aircraft heading information, aircraft altitude information, and aircraft attitude information;
displaying the aircraft heading information, the aircraft altitude information, and aircraft ground speed information, the aircraft ground speed information determined by comparing the aircraft latitude and longitude information;
displaying a three dimensional perspective grid on a display;
displaying the grid overlaid with geographical references;
allowing a user to preprogram a first landing zone;
calculating a second landing zone by projection based on aircraft movement;
displaying the first landing zone by highlighting or marking a corresponding section of the grid;
displaying the second landing zone by highlighting or marking a corresponding section of the grid; and
moving the grid on the display in response to the aircraft position by shifting the grid corresponding to the aircraft latitude and longitude information, rotating the grid along a surface of the grid corresponding to the aircraft heading information, resizing the grid corresponding to aircraft altitude information, and tilting the grid corresponding to aircraft attitude information.

10. A brownout/obscured landing system comprising:
a processor;
a display coupled to the processor; and
a memory operably coupled to the processor, the memory having program instructions stored therein, the processor being operable to execute the program instructions, the program instructions including:
instructions for receiving data indicating aircraft position;
instructions for displaying a three dimensional perspective grid on the display; and
instructions for moving the grid on the display in response to the aircraft position.

11. The brownout/obscured landing system as claimed in claim 10, wherein the instructions for receiving data indicating aircraft position includes:
instructions for receiving aircraft latitude and longitude information through a Global Positioning System;
instructions for receiving aircraft heading information;
instructions for receiving aircraft altitude information; and
instructions for receiving aircraft attitude information.

12. The brownout/obscured landing system as claimed in claim 11, wherein the instructions for moving the grid on the display includes:
instructions for shifting the grid corresponding to the aircraft latitude and longitude information;
instructions for rotating the grid along a surface of the grid corresponding to the aircraft heading information;
instructions for resizing the grid corresponding to aircraft altitude information; and
instructions for tilting the grid corresponding to aircraft tilt information.

13. The brownout/obscured landing system as claimed in claim 10, the program instructions further comprising:
instructions for displaying the grid overlaid with geographical references.

14. The brownout/obscured landing system as claimed in claim 11, the program instructions further comprising:
instructions for displaying the aircraft heading information;
instructions for displaying the aircraft altitude information; and
instructions for displaying aircraft ground speed information, the aircraft ground speed information determined by comparing the aircraft latitude and longitude information.

15. The brownout/obscured landing system as claimed in claim 10, the program instructions further comprising:
instructions for allowing a user to preprogram a landing zone; and
instructions for displaying the landing zone by highlighting or marking a section of the grid.

16. The brownout/obscured landing system as claimed in claim 10, the program instructions further comprising:
instructions for calculating a landing zone by projection based on a rate of decent and a decelerating airspeed; and
instructions for displaying the landing zone by highlighting or marking a section of the grid.

17. The brownout/obscured landing system as claimed in claim 10, the program instructions further comprising:
instructions for allowing a user to preprogram a first landing zone;
instructions for calculating a second landing zone by projection based on aircraft movement;
instructions for displaying the first landing zone by highlighting or marking a corresponding section of the grid; and
instructions for displaying the second landing zone by highlighting or marking a corresponding section of the grid.

18. A brownout/obscured landing system comprising:
a processor;
a display coupled to the processor; and
a memory operably coupled to the processor, the memory having program instructions stored therein, the processor being operable to execute the program instructions, the program instructions including:
instructions for receiving data indicating aircraft position, the data including aircraft latitude and longitude information received through a Global Positioning System, aircraft heading information, aircraft altitude information, and aircraft attitude information;
instructions for displaying the aircraft heading information, the aircraft altitude information, and aircraft ground speed information, the aircraft ground speed information determined by comparing the aircraft latitude and longitude information;
instructions for displaying a three dimensional perspective grid on a display;
instructions for displaying the grid overlaid with geographical references;
instructions for allowing a user to preprogram a first landing zone;
instructions for calculating a second landing zone by projection based on aircraft movement;
instructions for displaying the first landing zone by highlighting or marking a corresponding section of the grid;
instructions for displaying the second landing zone by highlighting or marking a corresponding section of the grid; and
instructions for moving the grid on the display in response to the aircraft position by shifting the grid corresponding to the aircraft latitude and longitude information, rotating the grid along a surface of the grid corresponding to the aircraft heading information, resizing the grid corresponding to aircraft altitude information, and tilting the grid corresponding to aircraft attitude information.

19. A kneeboard comprising:
a bottom member having an inner compartment;
a top member connected to the bottom member by a first axle;
a first flange and a second flange extending outwardly from the bottom member, the first flange having a first flange strap slot and a first flange spring slot, the second flange having a second flange strap slot and a second flange spring slot;
straps attached to the first flange strap slot and the second flange strap slot;
springs located in the first flange spring slot and the second flange spring slot for holding writing instruments, the springs having turns distanced less than a diameter of the writing instruments;
a first clamp located at a lower edge of the top member;
a second clamp located at an upper edge of the top member;
a tiltable surface connected to an upper surface of the second clamp by a second axle; the second axle extending widthwise across the kneeboard; and
a light emitting diode for lighting a top surface of the top member, the light emitting diode being removable and having a flexible neck for lighting a top surface of the top member or other areas where a light is needed.

20. The kneeboard as claimed in claim 19, wherein the bottom member has a concave bottom surface.

21. The kneeboard as claimed in claim 19, wherein the straps are of an elastic fabric material and include a storage pouch for storing notes and fabric loops for storing additional writing instruments or pilot tools.

22. The kneeboard as claimed in claim 19, further comprising:
a latch connecting the top member to the bottom member.

23. The kneeboard as claimed in claim 19, further comprising:
a display attached to the tiltable surface.

24. The kneeboard as claimed in claim 23, wherein the display includes a processor and a memory operably coupled to the processor, the memory having program instructions stored therein, the processor being operable to execute the program instructions, the program instructions including:
instructions for implementing a brownout/obscured landing system that receives data indicating aircraft position, displays a three dimensional perspective grid on the display, and moves the grid on the display in response to the aircraft position.

25. A method for providing a military moving map system on an interactive display, comprising:
storing maps and geographically referenced overlays;
displaying one of the maps and geographically referenced overlays;
stitching together said maps at a same scale and trimming map overlaps to reduce blur;
receiving aircraft latitude and longitude information through a Global Positioning System;
receiving aircraft heading information through a compass or a gyrocompass;
displaying aircraft position on said one of the maps and geographically referenced overlays using the aircraft latitude and longitude information;
determining aircraft direction and aircraft ground speed by determining a change in the aircraft latitude and longitude information;
displaying the aircraft direction on the interactive display;
displaying the aircraft ground speed on the interactive display;
displaying the aircraft heading on the interactive display;
allowing a user to zoom into or out of said one of the maps and geographically referenced overlays;
allowing the user to change the maps and geographically referenced overlays for display;
allowing the user to mark locations on the maps through the interactive display;
allowing the user to pan maps that have been stitched together;
allowing the user to center the maps on a current geo-location reference after panning;
displaying features on the interactive display when needed and removing features on the interactive display when unused;
allowing the user to change data formats by touching data on the interactive display;
allowing a user to request a line be drawn on the interactive display, the line extending from a current position of an aircraft to another position;
allowing the user to create a route and showing a distance of the route and fuel required to complete the route;
allowing the user to display distance, heading, and fuel required between any to known points;
allowing the user to input data by breaking the data into logical segments;
allowing the user to display actual aircraft position on the interactive display; and
allowing the user to display a track of an aircraft on the interactive display.
